(19) United States
(12) Patent Application Publication
(10) Pub. No.: US 2024/0217609 A1
(43) Pub. Date: Jul. 4, 2024

(54) ELECTRIC SCOOTER

(71) Applicant: Greenworks (Jiangsu) Co., Ltd., Changzhou (CN)

(72) Inventor: Yongshen HU, Changzhou (CN)

(73) Assignee: Greenworks (Jiangsu) Co., Ltd., Changzhou (CN)

(21) Appl. No.: 18/398,155

(22) Filed: Dec. 28, 2023

(30) Foreign Application Priority Data
Dec. 29, 2022 (CN) 202223540936.2
Dec. 29, 2022 (CN) 202223572707.9

(51) Int. Cl. B62J 43/16; B62J 43/20

(52) U.S. Cl. CPC B62J 43/16; B62J 43/20

(57) ABSTRACT

An electric scooter is provided, which includes: a vehicle body component including a deck and a battery compartment mounted to the deck and includes a compartment body fixedly mounted to the deck and a compartment cover pivotally mounted to the compartment body; a front wheel component directly or indirectly fixedly mounted to one end of the vehicle body component; and a rear wheel component directly or indirectly fixedly mounted to the other end of the vehicle body component. At least one of the compartment body and the compartment cover is provided with a jacking component. When the compartment cover is closed, one end of the jacking component abuts against the compartment body, and the other end of the jacking component abuts against the compartment cover.

### CROSS-REFERENCE

The present disclosure claims the priorities to Chinese Applications CN202223540936.2 and CN202223572707.9, both filed on Dec. 29, 2022, the contents of all of which are incorporated herein by reference in their entirety.

### TECHNICAL FIELD

Embodiments of the present disclosure relate to electric scooters.

### BACKGROUND

Some existing electric scooters often come with a specially designed battery component. The battery component may be a single piece, which is very large and inconvenient to carry. Moreover, for some existing electric scooters, the battery component may be fixed in the frame of the scooter and is not easy to disassemble. Therefore, existing electric scooters may cause inconvenience when they need to be charged.

### SUMMARY

Embodiments of the present disclosure provide electric scooters. In some exemplary embodiments, since the electric scooter is provided with a compartment body and a compartment cover pivotally mounted to the compartment body, the battery component may be disassembled and replaced more easily. Also, in some exemplary embodiments, since the compartment body or the compartment cover is provided with a jacking component, the problem of poor assembly of the compartment body and the compartment cover caused by deformation due to excessive length of the deck may be effectively avoided.

The present disclosure provides an electric scooter, which includes: a vehicle body component including a deck and a battery compartment mounted to the deck and includes a compartment body fixedly mounted to the deck and a compartment cover pivotally mounted to the compartment body; a front wheel component directly or indirectly fixedly mounted to one end of the vehicle body component; and a rear wheel component directly or indirectly fixedly mounted to the other end of the vehicle body component. At least one of the compartment body and the compartment cover is provided with a jacking component. When the compartment cover is closed, one end of the jacking component abuts against the compartment body, and the other end of the jacking component abuts against the compartment cover.

In some embodiments of the present disclosure, the jacking component includes a jacking post and a first elastic element cooperating with the jacking post, and when the compartment cover is closed, the jacking post abuts against the compartment body or the compartment cover, while the first elastic element undergoes elastic deformation under the action of the jacking post.

In some embodiments of the present disclosure, one end of the jacking post that is away from the first elastic element is provided with a boss, and the boss is in a convex arc shape, so that the contact between the boss and the compartment body or the compartment cover is a line contact or a point contact.

In some embodiments of the present disclosure, the compartment body or the compartment cover supported by the jacking post is provided with a positioning groove that cooperates with the jacking post.

In some embodiments of the present disclosure, the positioning groove is provided with a guiding portion to guide the jacking post to slide out of the positioning groove.

In some embodiments of the present disclosure, the compartment cover is provided with a receiving groove, the jacking component is located in the receiving groove, and the first elastic element is located between a bottom wall of the receiving groove and the jacking post.

In some embodiments of the present disclosure, a limiting wall is provided at an opening of the receiving groove, and the limiting wall cooperates with the jacking post, so that the jacking post partially passes through the opening to the outside of the receiving groove.

In some embodiments of the present disclosure, the receiving groove is provided with an assembly opening, and the jacking component enters the receiving groove through the assembly opening.

In some embodiments of the present disclosure, the receiving groove is further provided with a limiting plate that cooperates with the assembly opening to prevent the jacking component from sliding out of the receiving groove through the assembly opening.

In some embodiments of the present disclosure, the compartment body is provided with a battery guiding rail.

The electric scooter of the present disclosure is provided with a compartment body and a compartment cover pivotally mounted to the compartment body, so that the battery component may be more conveniently disassembled and replaced. The compartment body or the compartment cover is equipped with a jacking component, which may effectively avoid the problem of poor assembly of the compartment body and the compartment cover caused by deformation due to the excessively long deck.

### BRIEF DESCRIPTION OF THE DRAWINGS

FIG. 1 is a perspective view of an electric scooter according to exemplary embodiments of the present disclosure;

FIG. 2 is a perspective view of the electric scooter shown in FIG. 1 with a compartment cover opened;

FIG. 3 is a perspective view of a vehicle body component of the electric scooter shown in FIG. 1;

FIG. 4 is a perspective view of the vehicle body component shown in FIG. 3 from another angle;

FIG. 5 is an exploded view of the vehicle body component shown in FIG. 3;

FIG. 6 is an exploded view of a compartment cover and a jacking component according to exemplary embodiments of the present disclosure;

FIG. 7 is an enlarged schematic view of part A of FIG. 6;

FIG. 8 is a schematic view of the cooperation between a deck and a jacking component according to exemplary embodiments of the present disclosure;

FIG. 9 is an enlarged schematic view of part B of FIG. 8;

FIG. 10 is an exploded view of a compartment body, a shaft cover, and a compartment cover according to exemplary embodiments of the present disclosure;

FIG. 11 is a schematic view of the cooperation between a shaft cover and a compartment cover according to exemplary embodiments of the present disclosure;

FIG. 12 is a schematic view of the shaft cover and the compartment cover shown in FIG. 11 from another angle;

FIG. 13 is a cross-sectional view of a shaft cover and a compartment cover according to exemplary embodiments of the present disclosure;

FIG. 14 is a perspective view of a shaft cover according to exemplary embodiments of the present disclosure; and

FIG. 15 is an enlarged schematic view of part C of FIG. 10.

### DETAILED DESCRIPTION

In order to make the purpose, technical solutions, and advantages of the present disclosure clearer, the present disclosure will be described in detail below with reference to the drawings and exemplary embodiments.

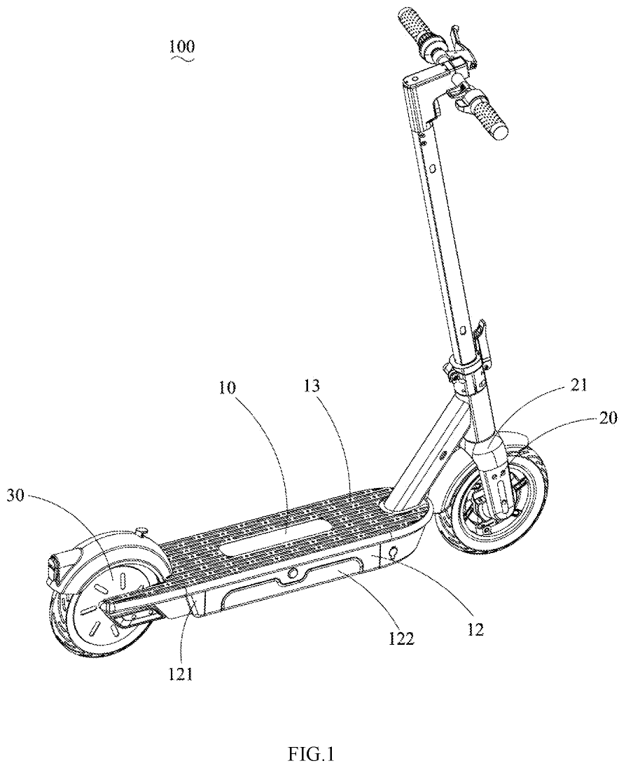

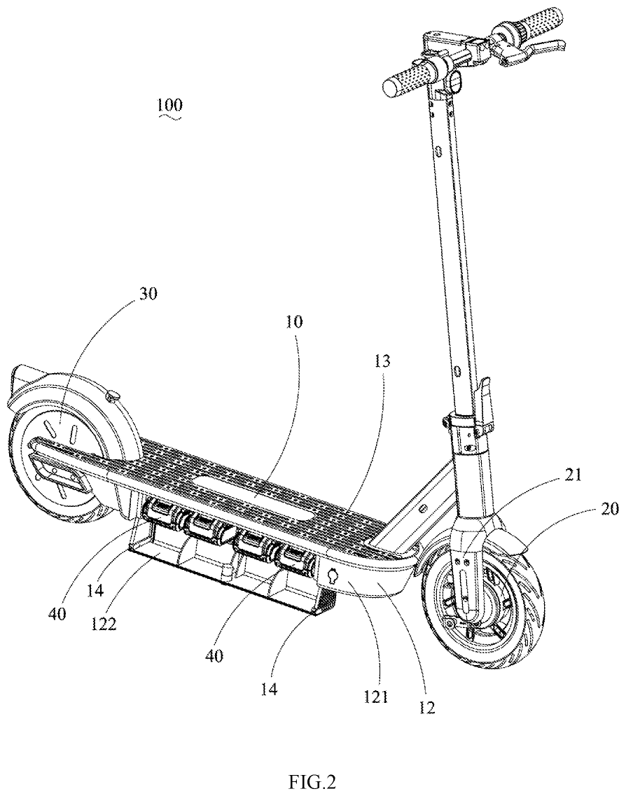

Please refer to FIG. 1 and FIG. 2. Exemplary embodiments of the present disclosure disclose an electric scooter 100. The electric scooter 100 includes a vehicle body component 10, a front wheel component 20, and a rear wheel component 30. The front wheel component 20 is directly or indirectly fixedly mounted to one end of the vehicle body component 10. The rear wheel component 30 is directly or indirectly fixedly mounted to the other end of the vehicle body component 10. For example, the front wheel component 20 is indirectly fixedly mounted to one end of the vehicle body 10 through a front fork 21, and the rear wheel component 30 is directly mounted to the other end of the vehicle body component 10.

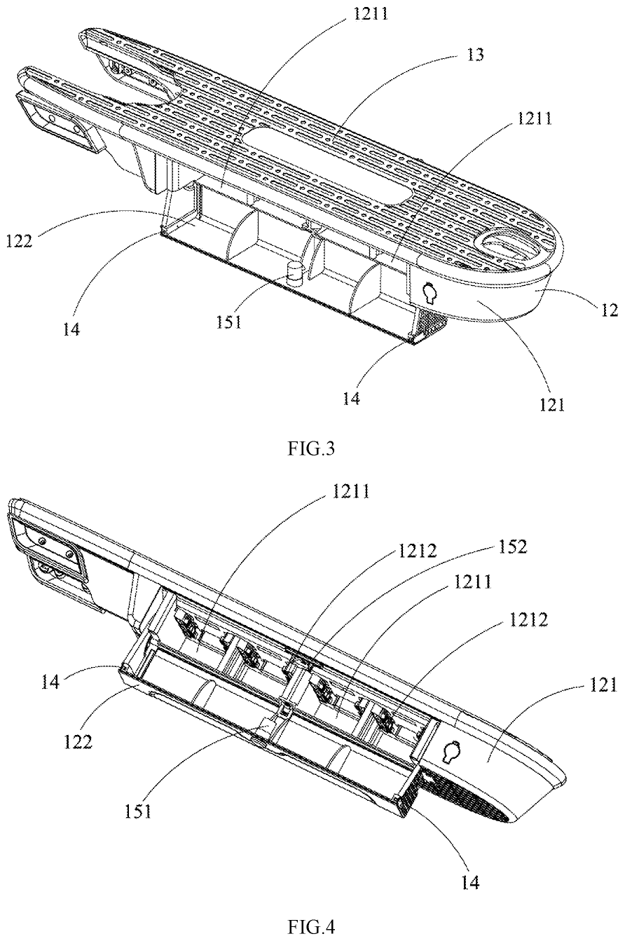

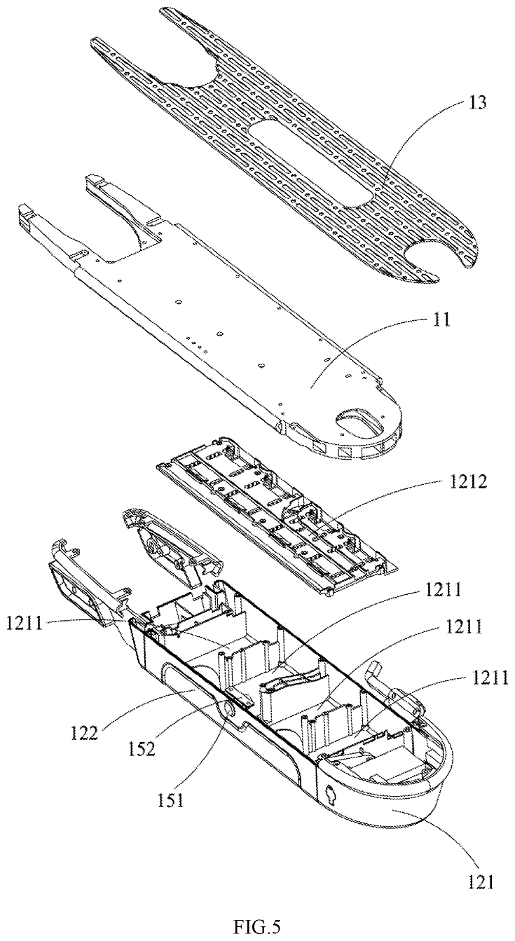

Referring to FIGS. 3, 4, 5, and 10, the vehicle body component 10 includes a deck 11, a battery compartment 12 mounted to the deck 11, and an anti-slip pad 13 mounted to the deck 11. For example, the anti-slip pad 13 is located above the deck 11, and the battery compartment 12 is located below the deck 11. The battery compartment 12 is used to accommodate the battery component 40 and includes a compartment body 121, a shaft cover 123, and a compartment cover 122. The compartment body 121, the shaft cover 123, and the compartment cover 122 are fixedly mounted to the deck 11. The compartment body 121 is provided with at least one battery receiving cavity 1211 to receive a battery component 40. For example, the compartment body 121 includes a plurality of battery receiving cavities 1211.

In exemplary embodiments, the compartment body 121 is also provided with a battery guiding rail 1212 to guide the battery component 40 into the battery receiving cavity 1211. The shaft cover 123 is fixedly mounted to the compartment body 121. The compartment cover 122 is pivotably mounted to the shaft cover 123 and cooperates with the battery receiving cavity 1211 to seal the battery component 40 in the battery receiving cavity 1211. At least one of the compartment body 121 and the compartment cover 122 is provided with a jacking component 14. When the compartment cover 122 is closed, one end of the jacking component 14 abuts against the compartment body 121 and the other end the jacking component 14 abuts against the compartment cover 122.

Compared with the conventional technique, the electric scooter 100 in the present disclosure is provided with a compartment body 121, a shaft cover 123 fixedly mounted to the compartment body 121, and a compartment cover 122 pivotally mounted to the shaft cover 123. Therefore, the battery component 40 may be disassembled and replaced more conveniently. Moreover, since the jacking component 14 is provided on the compartment body 121 or the compartment cover 122, when the compartment cover 122 is closed, the jacking component 14 can support and abut against a side wall of the compartment body 121, which may effectively avoid problems such as poor assembly of the compartment body 121 and the compartment cover 122 caused by deformation of the deck 11 due to being too long.

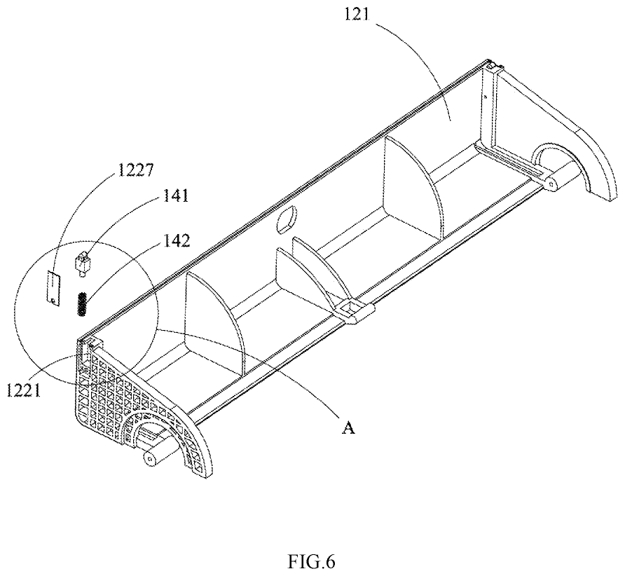

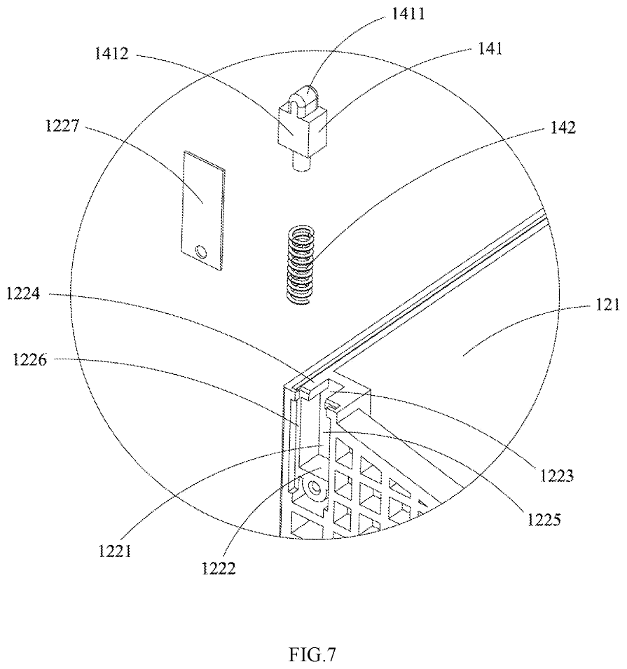

Please refer to FIG. 6 and FIG. 7. The jacking component 14 includes a jacking post 141 and a first elastic element 142 that cooperates with the jacking post 141. When the compartment cover 122 is closed, the jacking post 141 abuts against the compartment body 121 or the compartment cover 122. At this time, one end of the first elastic element 142 that faces away from the jacking post 141 abuts against the compartment cover 122 or the compartment body 121, and the first elastic element 142 deforms under the action of the jacking post 141.

In exemplary embodiments, a boss 1411 is provided at one end of the jacking post 141 that is away from the first elastic element 142. The boss 1411 is in a convex arc shape, so that the contact between the boss 1411 and the compartment body 121 or the compartment cover 122 is a line contact or a point contact, thereby reducing the friction between the jacking post 141 and the compartment body 121 or the compartment covers 122, which makes it easier for the user to open or close the compartment cover 122. Further, the compartment body 121 or the compartment cover 122 that is abutted by the jacking post 141 is provided with a positioning groove 111 that matches the jacking post 141. A guiding portion 1111 is provided in the positioning groove 111 to guide the jacking post 141 to slide out of the positioning groove 111.

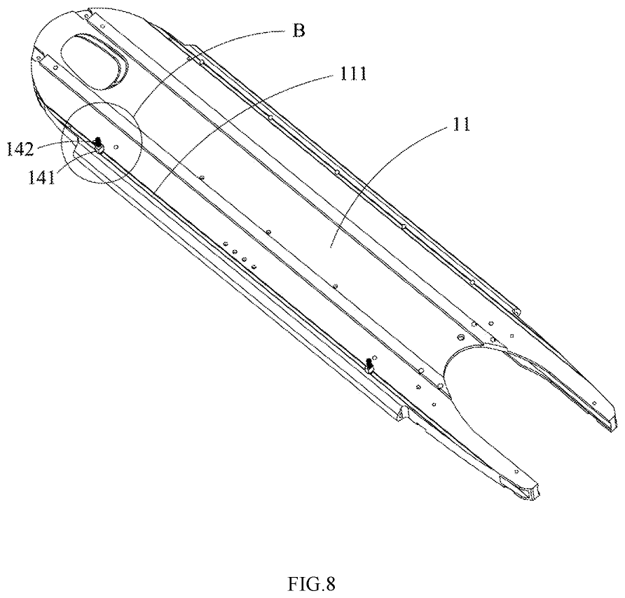

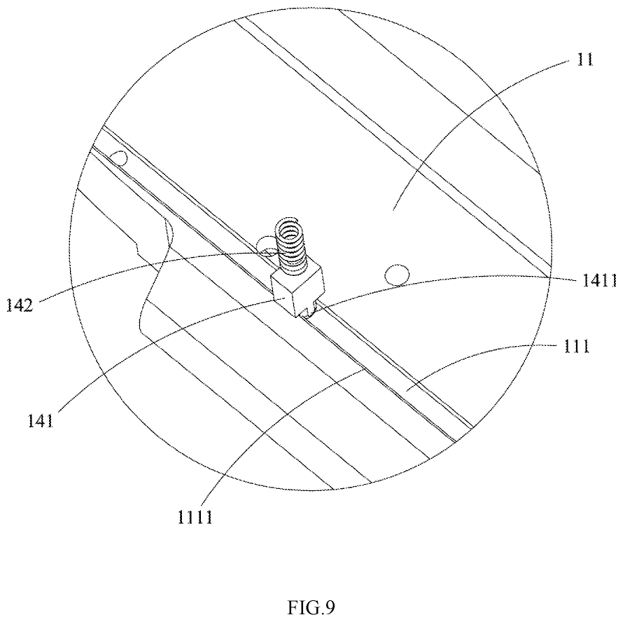

Please refer to FIGS. 7 to 9. In exemplary embodiments, the jacking component 14 is provided on the compartment cover 122, and the positioning groove 111 is provided on the compartment body 121. The compartment cover 122 is also provided with a receiving groove 1221, and the jacking component 14 is disposed in the receiving groove 1221. The first elastic element 142 is located between a bottom wall 1222 of the receiving groove 1221 and the jacking post 141.

Please continue to refer to FIG. 7. A limiting wall 1224 is provided at an opening 1223 of the receiving groove 1221. The jacking post 141 also includes a main body 1412, and the boss 1411 protrudes outward from one end of the main body 1412. In a direction perpendicular to the extending direction of the receiving groove 1221, the width of the main body 1412 is greater than the width of the boss 1411, and the width of the boss 1411 is not greater than the width of the opening 1223. With this configuration, when the first elastic element 142 pops the jacking post 141 out, the limiting wall 1224 cooperates with the main body 1412, so that the main body 1412 is located in the receiving groove 1221 and the boss 1411 can pass through the opening 1223 to the outside of the receiving groove 1221, so as to support and abut against the side wall of the compartment body 121.

In exemplary embodiments, the receiving groove 1221 is provided with an assembly opening 1225, a mounting groove 1226, and a limiting plate 1227. The jacking component 14 enters the receiving groove 1221 through the assembly opening 1225, and the limiting plate 1227 is mounted in the mounting groove 1226, thus sealing the assembly opening 1225 to prevent the jacking component 14 from sliding out of the receiving groove 1221 through the assembly opening 1225.

In exemplary embodiments, the number of the jacking components 14 is two, and these two jacking components 14 are respectively located on two sides of the compartment cover 122. However, it can be understood that in other exemplary embodiments, the number and location of the jacking components 14 can be determined as needed.

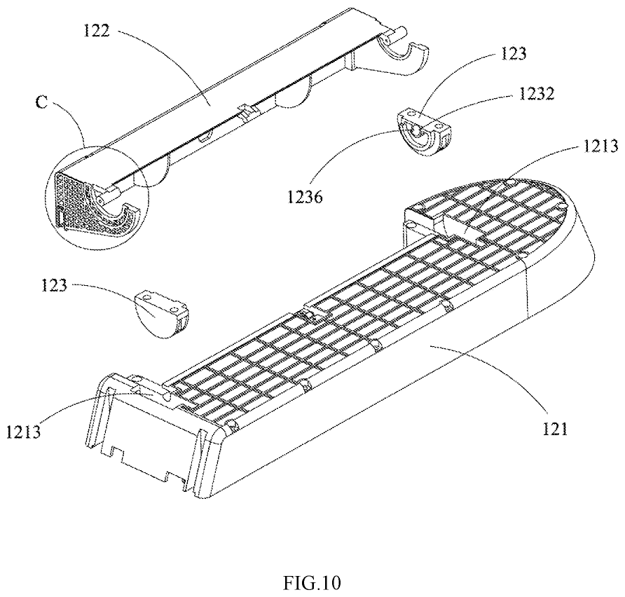

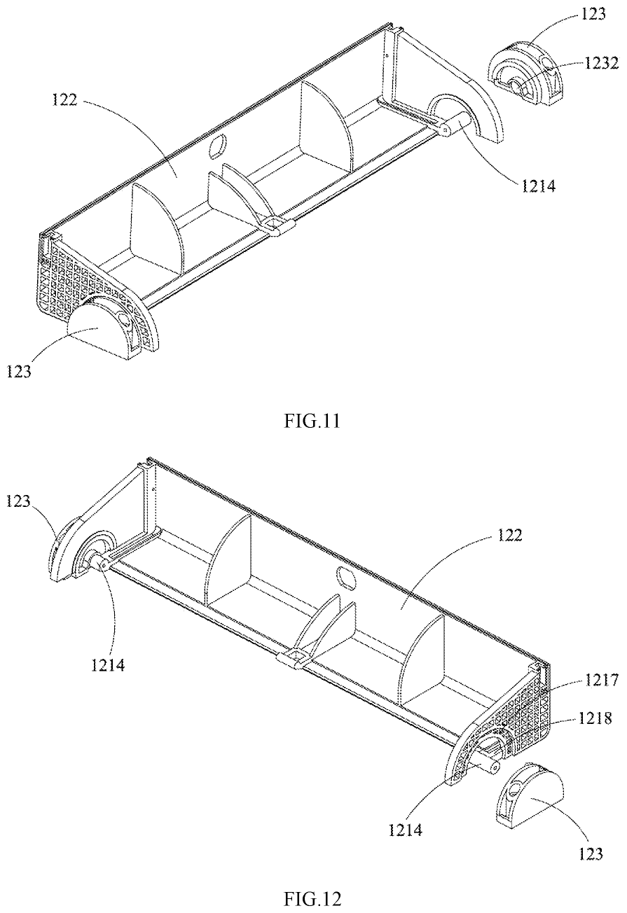

Referring to FIGS. 10 to 12, the compartment body 121 is also provided with a mounting cavity 1213, and the shaft cover 123 is received in the mounting cavity 1213. The shaft cover 123 is provided with a guiding structure, and the compartment cover 122 is provided with a directing structure that matches the guiding structure of the shaft cover 123. With this configuration, the electric scooter 100 according to exemplary embodiments of the present disclosure may effectively avoid the problem of jamming in the opening and closing of the compartment cover caused by deformation due to excessive length of the deck.

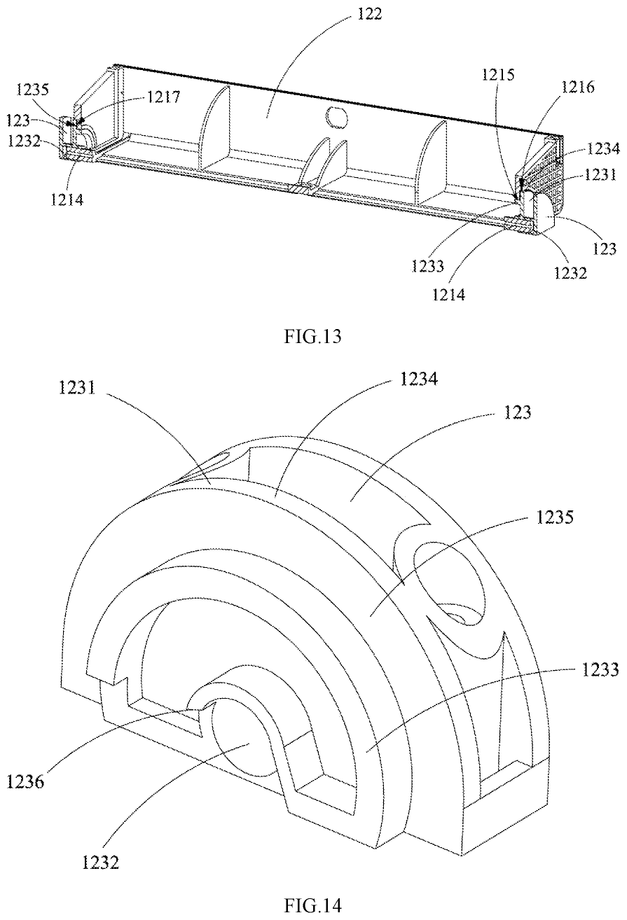

Referring to FIGS. 13 to 15, the shaft cover 123 includes a cover plate 1231, and the cover plate 1231 is provided with a shaft hole 1232 and the guiding structure. The guiding structure includes a first guiding wall 1233 protruding outward from the cover plate 1231, and the compartment cover 122 is provided with a pivot 1214 that cooperates with the shaft hole 1232. The directing structure includes a first directing wall 1215 that cooperates with the first guiding wall 1233. Due to the existence of the first guiding wall 1233 and the first directing wall 1215 cooperating with the first guiding wall 1233, the compartment cover 122 may be better supported. At the same time, the compartment cover 122 can also be guided to rotate around the shaft hole 1232, thereby avoiding the jamming problem when the compartment cover 122 is opened and closed. In exemplary embodiments, the first guiding wall 1233 and the first directing wall 1215 are both arc-shaped, and the first guiding wall 1233, the first directing wall 1215, and the shaft hole 1232 are coaxial.

Further, the guiding structure includes a second guiding wall 1234. The directing structure further includes a second directing wall 1216 that cooperates with the second guiding wall 1234. In this way, with the cooperation of the second guiding wall 1234 and the second directing wall 1216, the compartment cover 122 may be better supported. At the same time, the compartment cover 122 can be guided to rotate around the shaft hole 1232, thereby preventing the compartment cover 122 from being stuck when opening and closing. In exemplary embodiments, the second guiding wall 1234 and the second directing wall 1216 are arc-shaped, and the second guiding wall 1234, the second directing wall 1216, and the shaft hole 1232 are coaxial.

A first abutting surface 1235 is also provided between the first guiding wall 1233 and the second guiding wall 1234, and a second abutting surface 1217 is provided between the first directing wall 1215, and the second directing wall 1216. The first abutting surface 1235 cooperates with the second abutting surface 1217. With the cooperation of the first abutting surface 1235 and the second abutting surface 1217, the compartment cover 122 may be better limited between a pair of the shaft covers 123, and the shaking of the compartment cover 122 is effectively avoided, thereby avoiding the problem of poor assembly of the compartment body 121 and the compartment cover 122 that is caused by the shaking of the compartment cover 122.

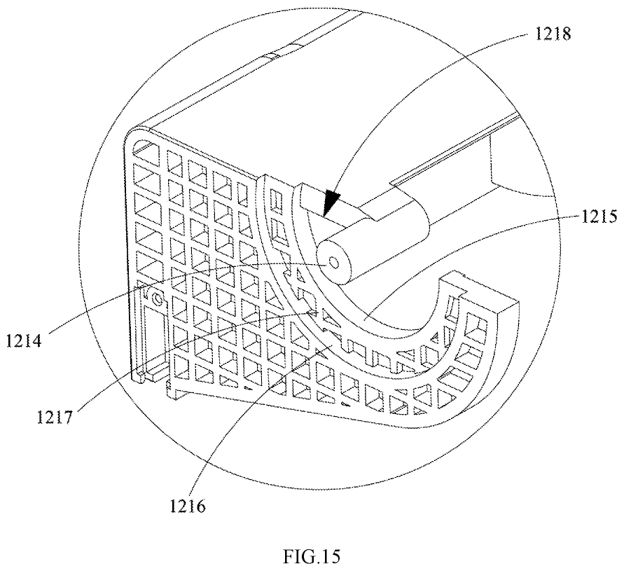

Please refer to FIG. 14 again, the shaft cover 123 is also provided with a first limiting arm 1236, and the compartment cover 122 is provided with a second limiting arm 1218 that cooperates with the first limiting arm 1236. The first limiting arm 1236 cooperates with the second limiting arm 1218 to limit the rotation range of the compartment cover 122.

In exemplary embodiments, please refer to FIGS. 3, 4 and 5. The battery compartment 12 is also provided with a lock component 15. The lock component 15 includes a duck tongue lock 151 provided on the compartment cover 122 and a locking buckle 152 provided on the compartment body 121. The locking buckle 152 cooperates with the duck tongue lock 151. Through the cooperation of the duck tongue lock 151 and the locking buckle 152, the compartment cover 122 can be locked on the compartment body 121, thereby preventing the battery component 40 from being stolen.

To sum up, the electric scooter 100 according to exemplary embodiments of the present disclosure is provided with a compartment body 121, a shaft cover 123 fixedly mounted to the compartment body 121, and a compartment cover 122 pivotally mounted to the shaft cover 123. Therefore, it is relatively convenient to disassemble and replace the battery component 40. Also, because the shaft cover 123 is provided with a guiding structure, and the compartment cover 122 is provided with a directing structure that cooperates with the guiding structure, it is possible to effectively avoid the smoothness issue of the opening and closing of the compartment cover 122 caused by deformation due to excessive length of the deck.

The above embodiments are only used to illustrate the technical solutions of the present disclosure and are not limiting. Although the present disclosure is described in detail with reference to the exemplary embodiments, those of ordinary skill in the art should understand that modification and equivalent substitutions to the technical solutions of the present disclosure can be made without departing from the scope of the technical solution of the present disclosure.

What is claimed is:

1. An electric scooter, comprising:
a vehicle body component, including a deck and a battery compartment, wherein the battery compartment is mounted to the deck and includes a compartment body fixedly mounted to the deck and a compartment cover pivotally mounted to the compartment body;
a front wheel component, directly or indirectly fixedly mounted to a first end of the vehicle body component; and
a rear wheel component, directly or indirectly fixedly mounted to a second end of the vehicle body component,
wherein
at least one of the compartment body and the compartment cover is provided with a jacking component, and
when the compartment cover is closed, a first end of the jacking component abuts against the compartment body, and a second end of the jacking component abuts against the compartment cover.

2. The electric scooter according to claim 1, wherein
the jacking component includes a jacking post and a first elastic element cooperating with the jacking post, and
when the compartment cover is closed, the jacking post abuts against the compartment body or the compartment cover, while the first elastic element undergoes elastic deformation under the action of the jacking post.

3. The electric scooter according to claim 2, wherein
one end of the jacking post that is away from the first elastic element is provided with a boss, and
the boss is in a convex arc shape, so that the contact between the boss and the compartment body or the compartment cover is a line contact or a point contact.

4. The electric scooter according to claim 2, wherein the compartment body or the compartment cover supported by the jacking post is provided with a positioning groove that cooperates with the jacking post.

5. The electric scooter according to claim 4, wherein the positioning groove is provided with a guiding portion to guide the jacking post to slide out of the positioning groove.

6. The electric scooter according to claim 2, wherein
the compartment cover is provided with a receiving groove,
the jacking component is located in the receiving groove, and
the first elastic element is located between a bottom wall of the receiving groove and the jacking post.

7. The electric scooter according to claim 6, wherein
a limiting wall is provided at an opening of the receiving groove, and
the limiting wall cooperates with the jacking post, so that the jacking post partially passes through the opening to outside of the receiving groove.

8. The electric scooter according to claim 7, wherein
the receiving groove is provided with an assembly opening, and
the jacking component enters the receiving groove through the assembly opening.

9. The electric scooter according to claim 8, wherein the receiving groove is further provided with a limiting plate that cooperates with the assembly opening to prevent the jacking component from sliding out of the receiving groove through the assembly opening.

10. The electric scooter according to claim 1, wherein the compartment body is provided with a battery guiding rail.
